(19) United States
(12) Patent Application Publication
(10) Pub. No.: US 2006/0065001 A1
(43) Pub. Date: Mar. 30, 2006

(54) System and method for extracting potable water from atmosphere

(76) Inventor: Diego Luis Felipe Bernardo Castanon Seoane, Lima (PE)

Correspondence Address: DIEGO, CASTANON,SECANE, HONDURAS 330, LIMA 18, PE

(21) Appl. No.: 10/949,249

(22) Filed: Sep. 27, 2004

(51) Int. Cl. F25D 17/06; F25D 21/00; F25D 21/14; B05D 3/02

(52) U.S. Cl. 62/291; 62/93; 62/272

(57) ABSTRACT

A system for producing potable water from the atmosphere includes first and second surfaces in parallel. Water condensation from the atmosphere forms on the surfaces in response to cooling of the surfaces. A seal is formed around the first and second surfaces to form an enclosure that is filled with a liquid. The system includes a cooling device positioned within the liquid within the enclosure, and a sensor circuit located near the first and second surfaces. The sensor circuit detects the amount of water condensate formed on the first and second surfaces. A wiper removes water condensate from the first and second surfaces when the sensor detects the amount of water condensate formed on the first and second surface exceeds a predetermined value. The water condensate removed from the first and second surfaces is collected for use as potable water.

### BACKGROUND

1. Field of the Invention

The present invention relates to the production of potable water. More particularly, the present invention relates to a system and method for extracting potable water from the atmosphere.

2. Background Information

Generally, natural freshwater resources are scarce or limited in many areas of the world, including areas such as, for example, deserts and arid lands, due to low precipitation and high salinity of surface and underground water. Shortage in supply of potable water and fresh water is increasing at a vast rate, as deserts expand and overtake fertile land, and as many of the natural ground water resources are being depleted. Furthermore, shifts in patterns of the global climate over time have resulted in a drop in the rate of rainfall in many areas. For example, hunger and starvation is spreading in areas such as, for example, Africa, because of shortage of fresh water to raise domestic animals and crops for food.

Sparse population and scattered population pockets in many areas make the application of water desalination and other water treatment technologies uneconomical due to the low demand and the high cost of water distribution from a central system over a wide stretch of land. For example, such methods of supplying potable water may be inaccessible to remote and/or impoverished areas of the world due to lack of natural resources, wealth, infrastructure and technical expertise. Alternatively, transportation of loads of fresh water is costly and exposes water to contamination en route and during handling and storage. For example, remote areas of the world may lack the necessary transportation infrastructure to allow transportation of potable water to these remote areas.

Accordingly, there is a need for localized production of fresh water to provide water for human drinking, and fresh water for raising animals and for irrigation as well as other human uses, that is reliable, affordable and produces little or no industrial pollution. Additionally, there is a need that the system may be transported and assembled in a number of remote areas inhabited by humans where little or no natural resources are available for providing potable water. The apparatus should be accessible to individuals with limited technical expertise and be available in a range of sizes so that it maybe used in areas that lack abundant space.

### SUMMARY OF THE INVENTION

A system and method are disclosed for extracting potable water from the atmosphere. In accordance with exemplary embodiments of the present invention, according to a first aspect of the present invention, a system for producing potable water from the atmosphere includes a first surface and a second surface arranged substantially parallel to the first surface. The first and second surfaces are comprised of a material on which water condensation from the atmosphere forms in response to a temperature differential between the material and the atmosphere. A seal is formed around a periphery of the first and second surfaces to form an enclosure between the first and second surfaces. The enclosure is filled with a liquid. The system includes a cooling device positioned within the liquid within the enclosure. The system includes a sensor circuit located proximate to the first and second surfaces. The sensor circuit is configured to detect an amount of water condensate formed on the first and second surfaces in response to cooling of the first and second surfaces by the liquid cooled by the cooling device. The system includes a wiper in contact with each of the first and second surfaces. The wiper is configured to remove water condensate from the respective first and second surfaces when the sensor circuit detects the amount of water condensate formed on the respective first and second surfaces exceeds a predetermined value. The system includes a collector for collecting the water condensate removed from the first and second surfaces for use as potable water.

According to the first aspect, the first and second surfaces can comprise glass. Alternatively, the first and second surfaces can comprise metal, plastic or the like. The liquid can comprise water. Alternatively, the first and second surfaces can comprise alcohol or the like. Each of the first and second surfaces can be substantially rectangular. Alternatively, each of the first and second surfaces can be substantially circular, substantially planar or the like. The system can include a sterilizer for sterilizing the collected water condensate to produce the potable water. The system can include an atmosphere flow regulator for passing atmosphere over the first and second surfaces. The system can include a control circuit for controlling the atmosphere flow regulator to control a passage of atmosphere over the first and second surfaces. A volume of atmosphere passed over the first and second surfaces can be dependent upon a humidity of the atmosphere detected by the sensor circuit. The system can include a cooling fluid supplier for supplying a cooling fluid through the cooling device to cool the liquid within the enclosure. For example, the cooling fluid supplier can comprise a condenser. The cooling device can comprise a refrigeration coil. Alternatively, the cooling device can comprise a plurality of pipes, and a cooling fluid can be passed through each of the plurality of pipes to cool the liquid within the enclosure. The wiper can comprise a squeegee.

According to a second aspect of the present application, a system for producing potable water from atmosphere includes a plurality of surfaces arranged to form a sealed enclosure. The enclosure is substantially filled with a liquid. Each of the plurality of surfaces is comprised of a material on which water condensation from the atmosphere forms when there is a temperature differential between the material and the atmosphere. The system includes a cooling coil positioned within the liquid within the enclosure. The cooling coil is configured to cool the liquid within the enclosure to cool the plurality of surfaces. The system includes at least one humidity sensor located proximate to the plurality of surfaces. The at least one humidity sensor is configured to detect an amount of water condensate formed on the plurality of surfaces. The system includes a plurality of wipers. Each of the plurality of wipers is associated with a surface of the plurality of surfaces. Each of the plurality of wipers is configured to remove water condensate from each of the plurality of surfaces when the at least one humidity sensor detects the amount of water condensate formed on the plurality of surfaces exceeds a predetermined value. The system includes a collector for collecting the water condensate removed from the plurality of surfaces for use as potable water.

According to the second aspect, each of the plurality of surfaces can comprise glass. Alternatively, each of the plurality of surfaces can comprise metal, plastic or the like. The liquid can comprise water. Alternatively, the liquid can comprise alcohol or the like. Each of the plurality of surfaces can be substantially rectangular. Alternatively, each of the plurality of surfaces can be substantially circular, substantially planar, or the like. The system can include a sterilizer for sterilizing the collected water condensate to produce the potable water. The system can include an atmosphere flow regulator for passing atmosphere over the plurality of surfaces. The system can include a control circuit for controlling the atmosphere flow regulator to control a passage of atmosphere over the plurality of surfaces. A volume of atmosphere passed over the plurality of surfaces can be dependent upon a humidity of the atmosphere detected by the at least one humidity sensor. The system can include a cooling fluid supplier for supplying a cooling fluid through the cooling device to cool the liquid within the enclosure. For example, the cooling fluid supplier can comprise a condenser. The cooling device can comprise a refrigeration coil. Alternatively, the cooling device can comprise a plurality of pipes, and a cooling fluid can be passed through each of the plurality of pipes to cool the liquid within the enclosure. Each of the plurality of wipers can comprise a squeegee.

According to a third aspect of the present invention, a system for producing potable water from atmosphere includes a conduit. The conduit is comprised of a material on which water condensation from the atmosphere forms in response to a temperature differential between the material and the atmosphere. A cooling fluid is passed through the conduit to cool the conduit. The system includes a sensor circuit located proximate to a surface of the conduit. The sensor circuit is configured to detect an amount of water condensate formed on the surface of the conduit in response to cooling of the conduit by the cooling fluid. The system includes a wiper in circumferential contact with the surface of the conduit. The wiper is configured to remove water condensate from the surface of the conduit when the sensor circuit detects the amount of water condensate formed on the surface of the conduit exceeds a predetermined value. The system includes a collector for collecting the water condensate removed from the conduit for use as potable water.

According to the third aspect, the conduit can comprise glass. Alternatively, the conduit can comprise metal, plastic or the like. The cooling fluid can comprise a refrigerant. The conduit can comprise a coil. The system can include a sterilizer for sterilizing the collected water condensate to produce the potable water. The system can include an atmosphere flow regulator for passing atmosphere over the surface of the conduit. The system can include a control circuit for controlling the atmosphere flow regulator to control a passage of atmosphere over the surface of the conduit. A volume of atmosphere passed over the surface of the conduit is dependent upon a humidity of the atmosphere detected by the sensor circuit. The system can include a cooling fluid supplier for supplying the cooling fluid through the conduit. The cooling fluid supplier can comprise a condenser. The wiper can comprise a squeegee.

According to a fourth aspect of the present invention, a system for producing potable water from atmosphere includes a first surface, and a second surface arranged substantially parallel to the first surface. The first and second surfaces are comprised of a material on which water condensation from the atmosphere forms in response to a temperature differential between the material and the atmosphere. A seal is formed around a periphery of the first and second surfaces to form an enclosure between the first and second surfaces. The enclosure is filled with a liquid. The system includes means for cooling positioned within the liquid within the enclosure. The system includes sensing means for detecting an amount of water condensate formed on the first and second surfaces in response to cooling of the first and second surfaces by the liquid cooled by the means for cooling. The sensing means is located proximate to the first and second surfaces. The system includes means for removing water condensate from the respective first and second surfaces when the sensing means detects the amount of water condensate formed on the respective first and second surfaces exceeds a predetermined value. The means for removing is in contact with each of the first and second surfaces. The system includes means for collecting the water condensate removed from the first and second surfaces for use as potable water.

According to the fourth aspect, the first and second surfaces can comprise glass. Alternatively, the first and second surfaces can comprise metal, plastic or the like. The liquid can comprise water. Alternatively, the liquid can comprise alcohol or the like. Each of the first and second surfaces can be substantially rectangular. Alternatively, each of the first and second surfaces can be substantially circular, substantially planar, or the like. The system can include means for sterilizing the collected water condensate to produce the potable water. The system can include means for regulating a passage of atmosphere over the first and second surfaces. The system can include means for controlling the means for regulating to control the passage of atmosphere over the first and second surfaces. A volume of atmosphere passed over the first and second surfaces can be dependent upon a humidity of the atmosphere detected by the sensing means. The system can include means for supplying a cooling fluid through the means for cooling to cool the liquid within the enclosure. The means for supplying can comprise a condenser means. The means for cooling can comprise a refrigeration coil means. Alternatively, the means for cooling can comprise a plurality of conduit means. A cooling fluid can be passed through each of the plurality of conduit means to cool the liquid within the enclosure. The means for removing can comprise a wiper means.

According to a fifth aspect of the present invention, a system for producing potable water from atmosphere includes a plurality of surfaces arranged to form a sealed enclosure. The enclosure is substantially filled with a liquid. Each of the plurality of surfaces is comprised of a material on which water condensation from the atmosphere forms when there is a temperature differential between the material and the atmosphere. The system includes means for cooling positioned within the liquid within the enclosure. The means for cooling is configured to cool the liquid within the enclosure to cool the plurality of surfaces. The system includes at least one means for sensing humidity located proximate to each of the plurality of surfaces. The at least one means for sensing humidity is configured to detect an amount of water condensate formed on a respective one of the plurality of surfaces. The system includes a plurality of means for removing water condensate from each of the plurality of surfaces when the at least one means for sensing humidity detects the amount of water condensate formed on the plurality of surfaces exceeds a predetermined value. Each of the plurality of means for removing is associated with a surface of the plurality of surfaces. The system includes means for collecting the water condensate removed from the plurality of surfaces for use as potable water.

According to the fifth aspect, each of the plurality of surfaces can comprise glass. Alternatively, each of the plurality of surfaces can comprise metal, plastic or the like. The liquid can comprises water. Alternatively, the liquid can comprise alcohol or the like. Each of the plurality of surfaces can be substantially rectangular. Alternatively, each of the plurality of surfaces can be substantially circular, substantially planar or the like. The system can include means for sterilizing the collected water condensate to produce the potable water. The system can include means for regulating a passage of atmosphere over the plurality of surfaces. The system can include means for controlling the means for regulating to control the passage of atmosphere over the plurality of surfaces. A volume of atmosphere passed over the plurality of surfaces is dependent upon a humidity of the atmosphere detected by the at least one means for sensing humidity. The system can include means for supplying a cooling fluid through the means for cooling to cool the liquid within the enclosure. The means for supplying can comprise a condenser means. The means for cooling can comprise a refrigeration coil means. Alternatively, the means for cooling can comprise a plurality of conduit means. A cooling fluid can be passed through each of the plurality of conduit means to cool the liquid within the enclosure. Each of the plurality of means for removing can comprise a wiper means.

According to a sixth aspect of the present invention, a system for producing potable water from atmosphere includes a conduit means for conveying a cooling fluid for cooling the conduit means. The conduit means is comprised of a material on which water condensation from the atmosphere forms in response to a temperature differential between the material and the atmosphere. The system includes a sensor means for detecting an amount of water condensate formed on the surface of the conduit means in response to cooling of the conduit means by the cooling fluid. The sensor means is located proximate to a surface of the conduit means. The system includes means for removing water condensate from the surface of the conduit means when the sensor means detects the amount of water condensate formed on the surface of the conduit means exceeds a predetermined value. The means for removing is in circumferential contact with the surface of the conduit means. The system includes means for collecting the water condensate removed from the conduit means for use as potable water.

According to the sixth aspect, the conduit means can comprise glass. Alternatively, the conduit means can comprise metal, plastic or the like. The cooling fluid can comprise a refrigerant. The conduit means can comprise a coil. The system can include means for sterilizing the collected water condensate to produce the potable water. The system can include means for regulating a passage of atmosphere over the surface of the conduit means. The system can include means for controlling the means for regulating to control the passage of atmosphere over the surface of the conduit means. A volume of atmosphere passed over the surface of the conduit means is dependent upon a humidity of the atmosphere detected by the sensor means. The system can include means for supplying the cooling fluid conveyed through the conduit means. The means for supplying can comprise a condenser means. The means for removing can comprise a wiper means.

According to a seventh aspect of the present invention, a system for producing potable water from atmosphere includes a first surface on which water condensate from the atmosphere forms, and a second surface on which the water condensate from the atmosphere forms. The second surface is arranged substantially parallel to the first surface. A seal is formed around a periphery of the first and second surfaces to form an enclosure between the first and second surfaces. The enclosure is filled with a liquid. The system includes a cooling device positioned within the liquid within the enclosure. The water condensate forms on the first and second surfaces in response to cooling of the first and second surfaces by the liquid cooled by the cooling device. The system includes a wiper in contact with each of the first and second surfaces. The wiper is configured to remove water condensate from the respective first and second surfaces at predetermined intervals. The system includes a collector for collecting the water condensate removed from the first and second surfaces. The system includes a sterilizer for sterilizing the collected water condensate to produce potable water.

According to a eighth aspect of the present invention, a system for producing potable water from atmosphere includes a conduit on which water condensate from the atmosphere forms. A cooling fluid is passed through the pipe to cool the pipe. The water condensate forms on a surface of the pipe in response to cooling of the pipe by the cooling fluid. The system includes a wiper in circumferential contact with the surface of the pipe. The wiper is configured to remove water condensate from the surface of the pipe at predetermined intervals. The system includes a collector for collecting the water condensate removed from the surface of the conduit. The system includes a sterilizer for sterilizing the collected water condensate to produce potable water.

According to a ninth aspect of the present invention, a method of producing potable water from atmosphere includes the steps of: a.) enclosing a cooling device within a liquid within an enclosure, wherein surfaces of the enclosure are comprised of a material on which water condensation from the atmosphere forms in response to a temperature differential between the material and the atmosphere; b.) cooling the liquid in the enclosure to cool the surfaces of the enclosure; c.) detecting an amount of water condensate formed on the surfaces in response to cooling of the surfaces by the liquid cooled by the cooling device; d.) removing water condensate from the surfaces of the enclosure when the amount of water condensate formed on the surfaces exceeds a predetermined value; and e.) collecting the water condensate removed from the surfaces of the enclosure for use as potable water.

According to the ninth aspect, the surfaces of the enclosure can comprise glass. Alternatively, the surfaces of the enclosure can comprise metal, plastic or the like. The liquid can comprise water. Alternatively, the liquid can comprise alcohol or like. The surfaces of the enclosure can be substantially rectangular. Alternatively, the surfaces of the enclosure can be substantially circular, substantially planar or the like. The method can include the steps of: f.) sterilizing the collected water condensate to produce the potable water; g.) regulating a passage of atmosphere over the surfaces of the enclosure, wherein a volume of atmosphere passed over the surfaces of the enclosure is dependent upon a humidity of the atmosphere; and h.) conveying a cooling fluid through the cooling device to cool the liquid within the enclosure.

According to a tenth aspect of the present invention, a method for producing potable water from atmosphere, comprising: a.) conveying a cooling fluid through a conduit to cool the conduit, wherein the conduit is comprised of a material on which water condensation from the atmosphere forms in response to a temperature differential between the material and the atmosphere; b.) detecting an amount of water condensate formed on a surface of the conduit in response to cooling of the conduit by the cooling fluid; c.) removing water condensate from the surface of the conduit when the amount of water condensate formed on the surface of the conduit exceeds a predetermined value; and d.) collecting the water condensate removed from the conduit for use as potable water.

According to the tenth aspect, the conduit can comprise glass. Alternatively, the conduit can comprise metal, plastic or the like. The cooling fluid can comprise a refrigerant. The conduit can comprise a coil. The method can include the steps of: e.) sterilizing the collected water condensate to produce the potable water; and f.) regulating a passage of atmosphere over the surface of the conduit, wherein a volume of atmosphere passed over the surface of the conduit is dependent upon a humidity of the atmosphere.

According to an eleventh aspect of the present invention, a system for producing potable water from atmosphere includes a plurality of surfaces arranged to form a sealed enclosure. Each of the plurality of surfaces is comprised of a material on which water condensation from the atmosphere forms when there is a temperature differential between the material and the atmosphere. The system includes a cooling fluid supplier in fluid communication with the sealed enclosure for supplying a cooling fluid within the sealed enclosure. The system includes at least one humidity sensor located proximate to the plurality of surfaces. The at least one humidity sensor is configured to detect an amount of water condensate formed on the plurality of surfaces. The system includes a plurality of wipers. Each of the plurality of wipers is associated with a surface of the plurality of surfaces. Each of the plurality of wipers is configured to remove water condensate from each of the plurality of surfaces when the at least one humidity sensor detects the amount of water condensate formed on the plurality of surfaces exceeds a predetermined value. The system includes a collector for collecting the water condensate removed from the plurality of surfaces for use as potable water.

According to the eleventh aspect, each of the plurality of surfaces can comprise glass, metal, plastic or other suitable material. The cooling fluid can comprise water, alcohol or other suitable cooling fluid. Each of the plurality of surfaces can substantially rectangular, substantially circular, substantially planar or other suitable configuration. The system can include a sterilizer for sterilizing the collected water condensate to produce the potable water. The system can include an atmosphere flow regulator for passing atmosphere over the plurality of surfaces. The system can include a control circuit for controlling the atmosphere flow regulator to control a passage of atmosphere over the plurality of surfaces. A volume of atmosphere passed over the plurality of surfaces can be dependent upon a humidity of the atmosphere detected by the at least one humidity sensor. The cooling fluid supplier can comprise a condenser or other suitable device. Each of the plurality of wipers can comprise a squeegee.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a system for producing potable water from atmosphere, in accordance with an exemplary embodiment of the present invention.

FIG. 2 is a diagram illustrating a system for producing potable water from atmosphere, in accordance with an alternative exemplary embodiment of the present invention.

FIG. 3 is a flowchart illustrating steps for producing potable water from atmosphere, in accordance with an exemplary embodiment of the present invention.

FIG. 4 is a flowchart illustrating steps for producing potable water from atmosphere, in accordance with an alternative exemplary embodiment of the present invention.

FIG. 5 is a diagram illustrating a system for producing potable water from atmosphere, in accordance with an alternative exemplary embodiment of the present invention.

### DETAILED DESCRIPTION OF THE PREFERRED EMBODIMENTS

Exemplary embodiments of the present invention are directed to a system and method for extracting potable water from the atmosphere. According to exemplary embodiments, the system can include a first surface, and a second surface arranged substantially parallel to the first surface. The first and second surfaces can be comprised of a material, such as, for example, glass, metal, plastic or the like, on which water condensation from the atmosphere can form in response to a temperature differential between the material and the atmosphere. A seal can be formed around the periphery of the first and second surfaces to form an enclosure between the first and second surfaces. The enclosure can be filled with a liquid, such as, for example, water, alcohol or the like, and a cooling device, such as, for example, a refrigeration coil, can be positioned within the liquid within the enclosure. A sensor circuit located proximate to the first and second surfaces can detect the amount of water condensate formed on the first and second surfaces in response to the cooling of the surfaces by the liquid that is cooled by the cooling device. A wiper, such as a squeegee or the like, in contact with each of the first and second surfaces can remove water condensate from the respective first and second surfaces when the sensor circuit detects the amount of water condensate formed on the respective first and second surfaces exceeds a predetermined value. A collector can collect the water condensate removed from the first and second surfaces for use as potable water. In addition, the collector can include a sterilizer for sterilizing the collected water condensate to produce the potable water. Furthermore, a control circuit connected to an atmosphere flow regulator can control the volume of atmosphere passed over the first and second surfaces to vary the amount of condensate formed on the surfaces to increase or decrease the amount of potable water produced by the system.

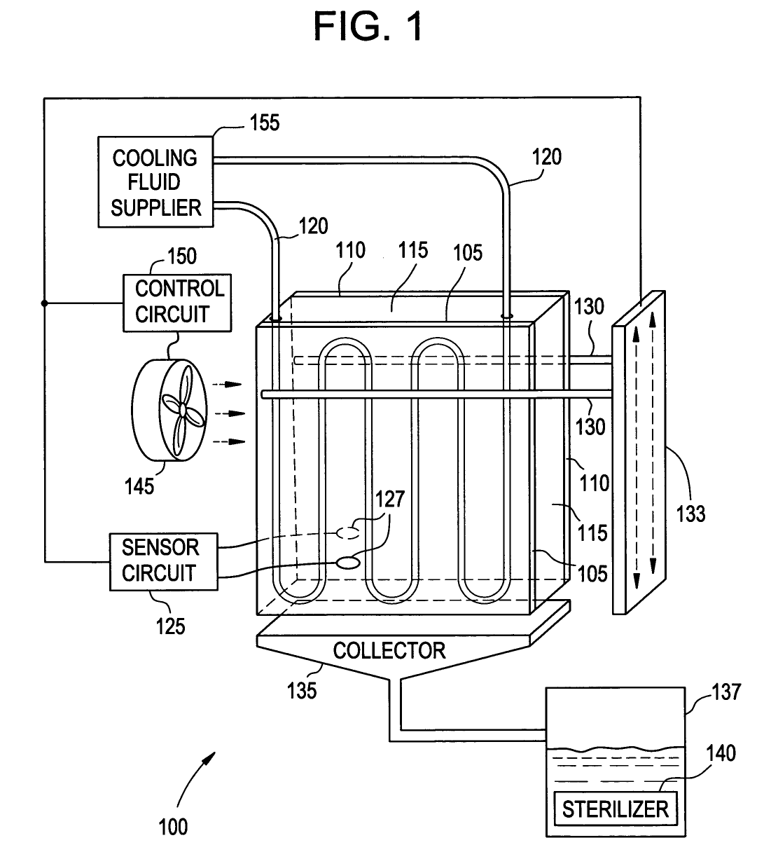

These and other aspects of the present invention will now be described in greater detail. FIG. 1 is a diagram illustrating a system 100 for producing potable water from atmosphere, in accordance with an exemplary embodiment of the present invention. The system 100 includes a first surface 105 and a second surface 110. The second surface 110 can be arranged substantially parallel to the first surface 105. The first and second surfaces 105 and 110 can be comprised of a material on which water condensation from the atmosphere forms in response to a temperature differential between the material and the atmosphere. The material can be any suitable material on which water condensation can form in response to cooling of the material in a humid environment. For example, the material can be comprised of glass, metal, plastic or the like.

A seal 115 is formed around a periphery of the first and second surfaces 105 and 110 to form an enclosure between the first and second surfaces 105 and 110. The seal 115 can be comprised of the same material as the first and second surfaces 105 and 110, although the seal 115 can be comprised of any suitable material to form the enclosure. According to exemplary embodiments, the first and second surfaces 105 and 110 can be spaced apart from each other by any suitable distance to create an enclosure of any desired volume. According to one exemplary embodiment, the first and second surfaces 105 and 110 can be spaced apart by approximately one inch, although any suitable spacing distance can be used. According to exemplary embodiments, the enclosure is substantially completely filled with a liquid. Any suitable liquid can be used to substantially completely fill the enclosure, including water, alcohol, an appropriate gas in a liquid state or the like.

The system 100 includes a cooling device 120 positioned within the enclosure. The cooling device 120 can be comprised of any suitable mechanism capable of cooling the liquid within the enclosure. For example, the cooling device 120 can comprise a refrigeration coil. According to an alternatively exemplary embodiment, the cooling device 120 can comprise a plurality of pipes, in which a cooling fluid can be passed through each of the plurality of pipes to cool the liquid within the enclosure. Other such mechanisms and configurations can be used for the cooling device 120. The system 100 can include a cooling fluid supplier 155 connected to the cooling device 120 for supplying a cooling fluid through the cooling device 120 to cool the liquid within the enclosure. The cooling fluid supplier 155 can be, for example, a condenser or other suitable refrigeration device capable of providing the cooling fluid (e.g., freon, a freon substitute, water or the like fluid) through the cooling device 120. According to exemplary embodiments, the cooling device 120 is immersed in the liquid in the enclosure to more evenly distribute the cooling of the first and second surfaces 105 and 110, thereby allowing for more even water condensation across the entirety of first and second surfaces 105 and 110. Thus, the cooling device 120 cools the liquid in the enclosure, which, in turn, substantially evenly cools the first and second surfaces 105 and 110.

The system 100 includes a sensor circuit 125 located proximate to the first and second surfaces 105 and 110. The sensor circuit 125 is configured to detect the amount of water condensate formed on the first and second surfaces 105 and 110 in response to cooling of the first and second surfaces 105 and 110 by the liquid that is cooled by the cooling device 120. The sensor circuit 125 can comprise, for example, a humidity sensor or other suitable type of electrical or electronic sensor or circuit that is capable of detecting the presence and amount of water formed on a surface. The sensor circuit 125 can include, for example, a plurality of sensor pads 127 that rest on or near each of the first and second surfaces 105 and 110 and are in electrical communication with the sensor circuit 125. Any appropriate number of sensor pads 127 can be placed in any suitable locations over the first and second surfaces 105 and 110 to allow for a proper determination of the amount of water condensate formed on the surfaces.

The system 100 includes a wiper 130 in contact with each of the first and second surfaces 105 and 110. The wipers 130 can comprise a squeegee or any other suitable type of component capable of removing water from a surface, such as a brush or the like. Each of the wipers 130 is configured to remove water condensate from the respective first and second surfaces 105 and 110 when the sensor circuit 125 detects the amount of water condensate formed on the respective first and second surfaces 105 and 110 exceeds a predetermined value. The system 100 can include a wiper movement mechanism 133 that is configured to move the wipers 130 across each of the first and second surfaces 105 and 110. For example, the wipers 130 can be initially positioned at the top of the first and second surfaces 105 and 110 and wipe the surfaces in a downward direction to remove the water condensate, and then return to their respective initial positions. The wiper movement mechanism 133 can be in electrical communication with the sensor circuit 125 using any suitable type of electrical connection. The wiper movement mechanism 133 can be comprised of any suitable electrical, electronic and/or mechanical means capable of moving the wipers 130.

According to exemplary embodiments, when the sensor circuit 125 determines that the amount of water condensate formed on a surface exceeds the predetermined threshold, the sensor circuit 125 can activate the wiper movement mechanism 133 to move the appropriate wiper across the given surface (e.g., either or both wipers 130 across either or both of first and second surfaces 105 and 110). The predetermined threshold of water condensate can be based on such factors as the size of the first and second surfaces 105 and 110, the amount or rate at which water is desired to be produced, the relative humidity of the atmosphere and other similar factors. According to an exemplary embodiment, the sensor circuit 125 can be configured to adapt the predetermined threshold to accommodate changing conditions (e.g., lower the predetermined threshold if the relative humidity or the desired rate of water production increases). Thus, water condensate can be removed from each of the first and second surfaces 105 and 110 independently (e.g., based on the amount of water formed on each surface) or concurrently (e.g., a predetermined threshold reached on one surface activates wiping of both surfaces). According to an alternative exemplary embodiment, the predetermined threshold can be a timing interval to activate wiping of the first and second surfaces 105 and 110 either independently or concurrently at predetermined intervals.

The system 100 includes a collector 135 for collecting the water condensate removed from the first and second surfaces 105 and 110 for use as potable water. The collector 135 can be any suitable form of trap, basin, drain or the like that is capable of capturing or otherwise collecting and temporarily storing the water condensate removed from the first and second surfaces 105 and 110. The collector 135 can be located below the first and second surfaces 105 and 110 to capture the falling water condensate as it is removed from the surfaces by the wipers 130. The collector 135 can include a tank 137 for storing the collected water condensate. The collector 135 can include a sterilizer 140 for sterilizing the collected water condensate to produce the potable water. The sterilizer 140 can be located, for example, in or near the tank 137. The sterilizer 140 can be any suitable device capable of sterilizing water, such as, for example, any suitable chemical means (e.g., chlorine), a heating element (e.g., to boil the water), an ultraviolet radiation emitter, or the like.

The system 100 can include an atmosphere flow regulator 145 for passing atmosphere over the first and second surfaces 105 and 110. The atmosphere flow regulator 145 can be any suitable type of electrical, electronic or mechanical means capable of moving air over the first and second surfaces 105 and 110, such as, for example, a fan, a blower, or the like. The system 100 can also include a control circuit 150 for controlling the atmosphere flow regulator 145 to control the passage of atmosphere over the first and second surfaces 105 and 110. The control circuit 150 can be comprised of any suitable digital, analog, or mechanical means that is capable of controlling the rate of air flow produced by the atmosphere flow regulator 145. According to exemplary embodiments, the volume of atmosphere passed over the first and second surfaces 105 and 110 can be dependent upon, for example, the humidity of the atmosphere detected by the sensor circuit 125 (e.g., the volume of atmosphere passed over the surfaces can increase as the relative humidity decreases and vice versa).

For example, the control circuit 150 can be in electrical communication with the sensor circuit 125 using any suitable form of electrical connection. If the sensor circuit 125 detects that, for example, the rate of water condensation on the first and second surfaces 105 and 110 is decreasing (e.g., the interval between wiper activations is increasing) or the rate of water production is below a desired rate or threshold (e.g., the relative humidity of the atmosphere is decreasing), the sensor circuit 125 can send an electrical signal or command to the control circuit 150 to increase the rate of air flow from the atmosphere flow regulator 145. Alternatively, if the sensor circuit 125 detects that, for example, the rate of water condensation on the first and second surfaces 105 and 110 is increasing (e.g., the interval between wiper activations is decreasing) or the rate of water production is above a desired rate or threshold (e.g., the relative humidity of the atmosphere is increasing), the sensor circuit 125 can send an electrical signal or command to the control circuit 150 to decrease the rate of air flow from the atmosphere flow regulator 145 to maintain a steady or substantially constant production of potable water.

According to exemplary embodiments, the first and second surfaces 105 and 110 can be of any suitable configuration. For example, the size of the first and second surfaces 105 and 110 can depend on the desired amount of water production. Additionally, the first and second surfaces 105 and 110 can be substantially rectangular, substantially circular, substantially planar or the like.

Other alternative configurations of system 100 illustrated in FIG. 1 are possible. For example, the system 100 can include a plurality of surfaces arranged to form a sealed enclosure. The enclosure can be substantially filled with a liquid. Each of the plurality of surfaces can be comprised of a material on which water condensation from the atmosphere forms when there is a temperature differential between the material and the atmosphere. The system 100 can include a cooling coil (e.g., cooling device 120) positioned within the liquid within the enclosure. The cooling coil can be configured to cool the liquid within the enclosure to cool the plurality of surfaces. The system 100 can include at least one humidity sensor (e.g., sensor circuit 125) located proximate to the plurality of surfaces. Each of the at least one humidity sensor can be configured to detect an amount of water condensate formed on the plurality of surfaces. The system 100 can include a plurality of wipers (e.g., wipers 130). Each of the plurality of wipers can be associated with a surface of the plurality of surfaces. Each of the plurality of wipers can be configured to remove water condensate from each of the plurality of surfaces when the at least one humidity sensor detects the amount of water condensate formed on the plurality of surfaces exceeds a predetermined value. The system 100 can include a collector (e.g., collector 135) for collecting the water condensate removed from the plurality of surfaces for use as potable water. Thus, alternative exemplary embodiments of the present invention can form a rectangle, pentagon, octagon or other like enclosed structure in which water condensate can be removed from each side of the structure.

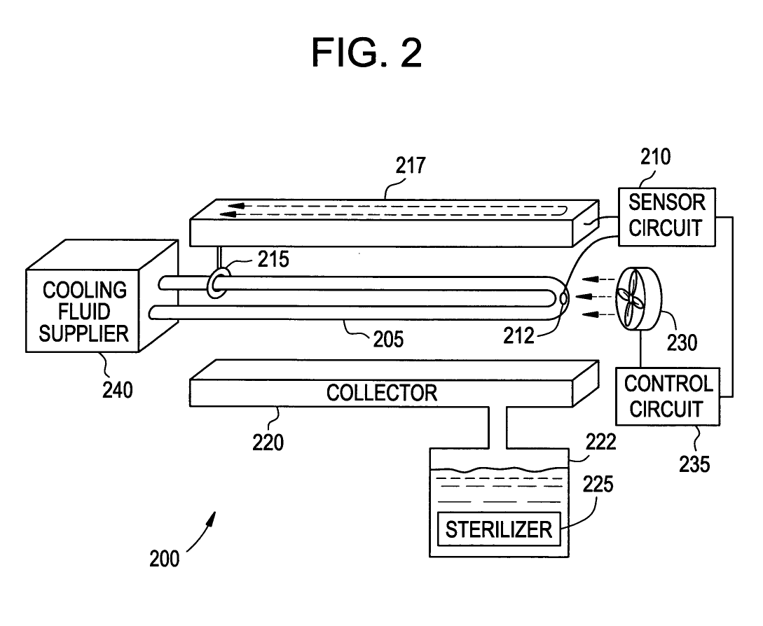

Alternatively, for example, FIG. 2 is a diagram illustrating a system 200 for producing potable water from atmosphere, in accordance with an alternative exemplary embodiment of the present invention. The system 200 includes a conduit 205. The conduit 205 is comprised of a material on which water condensation from the atmosphere forms in response to a temperature differential between the material and the atmosphere. The material can be any suitable material on which water condensation can form in response to cooling of the material in a humid environment. For example, the material can be comprised of glass, metal, plastic or the like. The conduit 205 can be of any suitable configuration, such as, for example, a coil, a single tube or pipe, a plurality of tubes or pipes, and the like. The conduit 205 can be of any suitable length and diameter, depending on the desired amount of water production.

According to exemplary embodiments, a cooling fluid is passed through the conduit 205 to cool the conduit 205 so that water condensate can form on the surface of the conduit 205. The cooling fluid can be comprised of any suitable refrigerant capable of cooling the surface of the conduit 205, including, for example, freon, a freon substitute, water, alcohol or other like cooling fluid. The system can include a cooling fluid supplier 240 for supplying the cooling fluid through the conduit 205. The cooling fluid supplier 240 can be, for example, a condenser or other suitable refrigeration device capable of providing the cooling fluid through the conduit 205.

The system 200 includes a sensor circuit 210 located proximate to the surface of the conduit 205. The sensor circuit 210 is configured to detect the amount of water condensate formed on the surface of the conduit 205 in response to cooling of the conduit 205 by the cooling fluid. The sensor circuit 210 can comprise, for example, a humidity sensor or other suitable type of electrical or electronic sensor or circuit that is capable of detecting the presence and amount of water formed on the surface of the conduit 205. The sensor circuit 210 can include, for example, a plurality of sensor pads 212 that rest on or near the surface of conduit 205 and are in electrical communication with the sensor circuit 210. Any appropriate number of sensor pads 212 can be placed in any suitable locations over the surface of the conduit 205 to allow for a proper determination of the amount of water condensate formed on the conduit 205.

The system 200 includes a wiper 215 in circumferential contact with the surface of the conduit 205. The wiper 215 is configured to remove water condensate from the surface of the conduit 205 when the sensor circuit 210 detects the amount of water condensate formed on the surface of the conduit 205 exceeds a predetermined value. For example, the wiper 215 can be in the form of a ring or donut shape. The wiper 215 can comprise a squeegee or any other suitable type of component capable of removing water from a surface, such as a brush or the like. The system 200 can include a wiper movement mechanism 217 that is configured to move the wiper 215 across the conduit 205. For example, the wiper 215 can be initially positioned at one end of the conduit 205 (starting near the cooling fluid supplier 240) and wipe the surface to the other end of the conduit 205 (ending near the cooling fluid supplier 240). The wiper 215 can then be returned to its original position either at that time or when another wiping of the conduit 205 occurs (e.g., creating a back and forth movement along the conduit 205).

However, any suitable number of wipers 215 can be used to wipe conduit 205. For example, two wipers 205 can be used to wipe the conduit 205, one at each end of the conduit 205 (both starting, e.g., near the cooling fluid supplier 240). Each wiper 205 can wipe a length of the conduit 205 and then return to its respective original position (e.g., near the cooling fluid supplier 240) either at that time or when another wiping of the conduit 205 occurs (e.g., creating a back and forth movement along the conduit 205). The wiper movement mechanism 217 can be in electrical communication with the sensor circuit 210 using any suitable type of electrical connection. The wiper movement mechanism 217 can be comprised of any suitable electrical, electronic and/or mechanical means capable of moving the wiper 215.

According to exemplary embodiments, when the sensor circuit 210 determines that the amount of water condensate formed on the surface of the conduit 205 exceeds the predetermined threshold, the sensor circuit 210 can activate the wiper movement mechanism 217 to move the wiper 215 across the conduit 205. The predetermined threshold will be based on factors such as the size and length of the conduit 205, the amount or rate at which water is desired to be produced, the relative humidity of the atmosphere and other similar factors. According to an exemplary embodiment, the sensor circuit 210 can be configured to adapt the predetermined threshold to accommodate changing conditions (e.g., lower the predetermined threshold if the relative humidity or the desired rate of water production increases). According to an alternative exemplary embodiment, the predetermined threshold can be a timing interval to activate wiping of the conduit 205 at predetermined intervals.

The system 200 includes a collector 220 for collecting the water condensate removed from the conduit 205 for use as potable water. The collector 220 can be any suitable form of trap, basin or the like that is capable of capturing or otherwise collecting and temporarily storing the water condensate removed from the conduit 205. The collector 220 can be located underneath the conduit 205 to capture the falling water condensate as it is removed from the conduit 205 by the wiper 215. The collector 220 can include a tank 222 for storing the collected water condensate. The collector 220 can include a sterilizer 225 for sterilizing the collected water condensate to produce the potable water. The sterilizer 225 can be located, for example, in the tank 222. The sterilizer 225 can be any suitable device capable of sterilizing water, such as, for example, any suitable chemical means, a heating element (e.g., to boil the water), an ultraviolet radiation emitter, or the like.

The system 200 can include an atmosphere flow regulator 230 for passing atmosphere over the surface of the conduit 205. The atmosphere flow regulator 230 can be any suitable type of electrical, electronic or mechanical means capable of moving air over the conduit 205, such as, for example, a fan, a blower, or the like. The system 200 can also include a control circuit 235 for controlling the atmosphere flow regulator 230 to control a passage of atmosphere over the surface of the conduit 205. The control circuit 235 can be comprised of any suitable digital, analog, or mechanical means that is capable of controlling the rate of air flow produced by the atmosphere flow regulator 235. According to exemplary embodiments, the volume of atmosphere passed over the conduit 205 can be dependent upon, for example, the humidity of the atmosphere detected by the sensor circuit 210.

For example, the control circuit 235 can be in electrical communication with the sensor circuit 210 using any suitable form of electrical connection. If the sensor circuit 210 detects that, for example, the rate of water condensation on the conduit 205 is decreasing (e.g., the interval between wiper activations is increasing) or the rate of water production is below a desired rate or threshold (e.g., the relative humidity of the atmosphere is decreasing), the sensor circuit 210 can send an electrical signal or command to the control circuit 235 to increase the rate of air flow from the atmosphere flow regulator 230. Alternatively, if the sensor circuit 210 detects that, for example, the rate of water condensation on the conduit 205 is increasing (e.g., the interval between wiper activations is decreasing) or the rate of water production is above a desired rate or threshold (e.g., the relative humidity of the atmosphere is increasing), the sensor circuit 210 can send an electrical signal or command to the control circuit 235 to decrease the rate of air flow from the atmosphere flow regulator 230 in order to maintain a steady or substantially constant production of potable water.

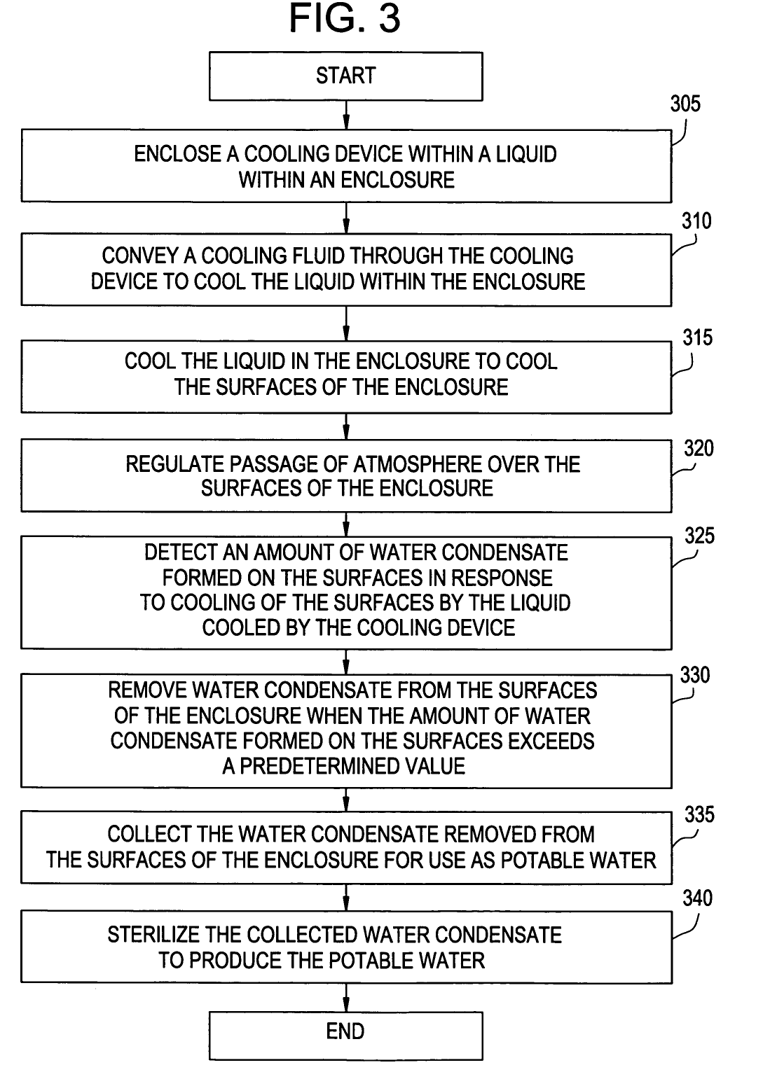

FIG. 3 is a flowchart illustrating steps for producing potable water from atmosphere, in accordance with an exemplary embodiment of the present invention. In step 305, a cooling device can be enclosed within a liquid within an enclosure. Surfaces of the enclosure can be comprised of a material on which water condensation from the atmosphere forms in response to a temperature differential between the material and the atmosphere. For example, the material can comprise glass, metal, plastic or the like. For example, the liquid can comprise water, alcohol or the like. In step 310, a cooling fluid can be conveyed through the cooling device to cool the liquid within the enclosure. In step 315, the liquid in the enclosure can be cooled to cool the surfaces of the enclosure. In step 320, a passage of atmosphere over the surfaces of the enclosure can be regulated. A volume of atmosphere passed over the surfaces of the enclosure can be dependent upon a humidity of the atmosphere. In step 325, an amount of water condensate formed on the surfaces in response to cooling of the surfaces by the liquid cooled by the cooling device can be detected. In step 330, water condensate can be removed from the surfaces of the enclosure when the amount of water condensate formed on the surfaces exceeds a predetermined value. In step 335, the water condensate removed from the surfaces of the enclosure can be collected for use as potable water. In step 340, the collected water condensate can be sterilized to produce the potable water.

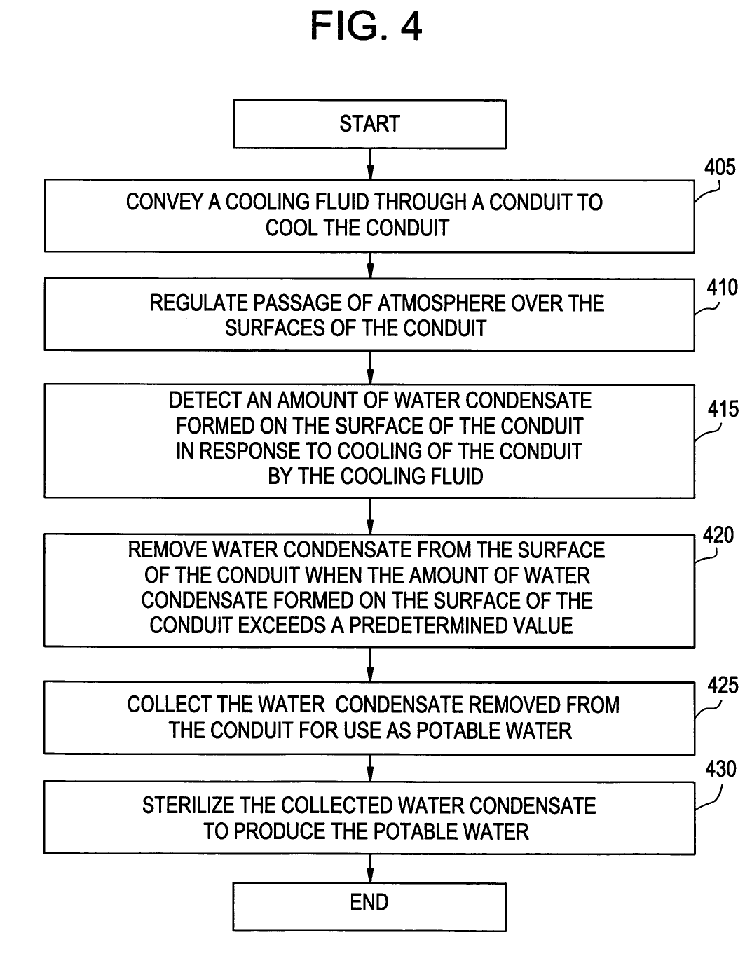

FIG. 4 is a flowchart illustrating steps for producing potable water from atmosphere, in accordance with an alternative exemplary embodiment of the present invention. In step 405, a cooling fluid can be conveyed through a conduit to cool the conduit. The conduit can be comprised of a material on which water condensation from the atmosphere forms in response to a temperature differential between the material and the atmosphere, such as, for example, glass, metal, plastic or the like. The conduit can of any suitable structure, such as a coil, tube or the like. The cooling fluid can be a refrigerant or the like. In step 410, a passage of atmosphere over the surface of the conduit can be regulated. A volume of atmosphere passed over the surface of the conduit can be dependent upon a humidity of the atmosphere. In step 415, an amount of water condensate formed on a surface of the conduit in response to cooling of the conduit by the cooling fluid can be detected. In step 420, water condensate can be removed from the surface of the conduit when the amount of water condensate formed on the surface of the conduit means exceeds a predetermined value. In step 425, the water condensate removed from the conduit means can be collected for use as potable water. In step 430, the collected water condensate can be sterilized to produce the potable water.

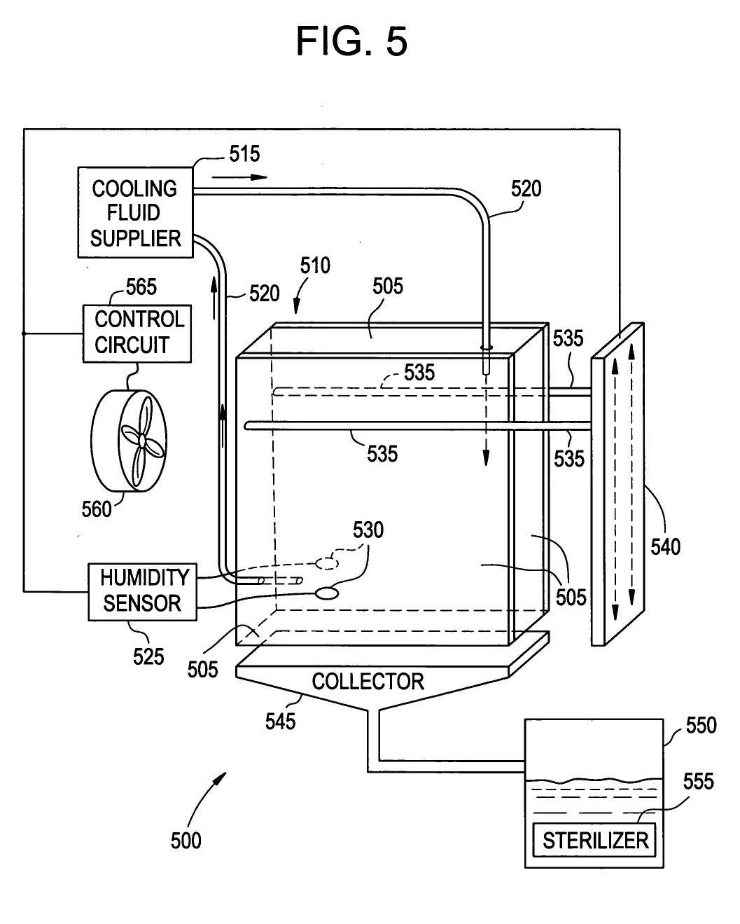

FIG. 5 is a diagram illustrating a system 500 for producing potable water from atmosphere, in accordance with an alternative exemplary embodiment of the present invention. The system 500 includes a plurality of surfaces 505 arranged to form a sealed enclosure 510. Each of the plurality of surfaces 505 can be comprised of a material on which water condensation from the atmosphere forms when there is a temperature differential between the material and the atmosphere. For example, each of the plurality of surfaces 505 can be comprised of glass, metal, plastic, or the like. Each of the plurality of surfaces 505 can be of any suitable configuration, such as substantially rectangular, substantially circular, substantially planar or the like.

The system 500 includes a cooling fluid supplier 515, such as a condenser or the like, in fluid communication with the sealed enclosure 510 for supplying a cooling fluid within the sealed enclosure 510. The cooling fluid can be, for example, water, alcohol, or other suitable cooling fluid. The cooling fluid supplier 515 can be configured to contain or otherwise store cooling fluid (e.g., as a tank) for supply to the sealed enclosure 510. The cooling fluid supplier 515 can be fluidly connected to the sealed enclosure 510 using, for example, pipes 520. According to an exemplary embodiment, one of the pipes 520 can be configured to bring cooling fluid from the cooling fluid supplier 515 to the sealed enclosure 510 (e.g., at or near the top of the sealed enclosure 510) to fill the sealed enclosure 510 with the cooling fluid. Another of the pipes 520 can be configured to return the cooling fluid from the sealed enclosure 510 (e.g., at or near the bottom of the sealed enclosure 510) to the cooling fluid supplier 515 for re-cooling and eventual re-supply to the sealed enclosure 510. Thus, the exemplary embodiment illustrated in FIG. 5 can provide a circulation system for circulating cooling fluid, in the sealed enclosure 510, that is cooled by the cooling fluid supplier 515.

The system 500 includes at least one humidity sensor 525 located proximate to the plurality of surfaces 505. The at least one humidity sensor 525 can be configured to detect an amount of water condensate formed on the plurality of surfaces 505. The at least one humidity sensor 525 can include, for example, a plurality of sensor pads 530 that rest on or near one or more of the plurality surfaces 505 and are in electrical communication with the at least one humidity sensor 525. Any appropriate number of sensor pads 530 can be placed in any suitable locations over the plurality of surfaces 505 to allow for a proper determination of the amount of water condensate formed on the surfaces.

The system 500 includes a plurality of wipers 535. Each of the plurality of wipers 535 can associated with a surface of the plurality of surfaces 505. Each of the plurality of wipers 535 can be configured to remove water condensate from each of the plurality of surfaces 505 when the at least one humidity sensor 525 detects the amount of water condensate formed on the plurality of surfaces 505 exceeds a predetermined value. Each of the plurality of wipers 535 can comprise a squeegee or any other suitable type of component capable of removing water from a surface, such as a brush or the like. The system 500 can include a wiper movement mechanism 540 that is configured to move the wipers 535 across each of the plurality of surfaces 505. For example, the wipers 535 can be initially positioned at or near the top of the plurality of surfaces 505 and wipe the surfaces in a downward direction (either concurrently or independently) to remove the water condensate, and then return to their respective initial positions. The wiper movement mechanism 540 can be in electrical communication with the at least one humidity sensor 525 using any suitable type of electrical connection. The wiper movement mechanism 540 can be comprised of any suitable electrical, electronic and/or mechanical means capable of moving the wipers 535.

The system 500 includes a collector 545 for collecting the water condensate removed from the plurality of surfaces 505 for use as potable water. The collector 545 can be any suitable form of trap, basin, drain or the like that is capable of capturing or otherwise collecting and temporarily storing the water condensate removed from the plurality of surfaces 505. The collector 545 can be located below the plurality of surfaces 505 to capture the falling water condensate as it is removed from the surfaces by the wipers 535. The collector 545 can include a tank 550 for storing the collected water condensate. The collector 545 can include a sterilizer 555 for sterilizing the collected water condensate to produce the potable water. The sterilizer 555 can be located, for example, in the tank 550 or separately from the tank 550. The sterilizer 555 can be any suitable device capable of sterilizing water, such as, for example, any suitable chemical means (e.g., chlorine), a heating element (e.g., to boil the water), an ultraviolet radiation emitter, or the like.

The system 500 can include an atmosphere flow regulator 560 for passing atmosphere over the plurality of surfaces. The atmosphere flow regulator 560 can be any suitable type of electrical, electronic or mechanical means capable of moving air over the plurality of surfaces 505, such as, for example, a fan, a blower, or the like. The system 500 can also include a control circuit 565 for controlling the atmosphere flow regulator 560 to control the passage of atmosphere over the plurality of surfaces 505. The control circuit 565 can be comprised of any suitable digital, analog, or mechanical means that is capable of controlling the rate of air flow produced by the atmosphere flow regulator 560. According to exemplary embodiments, the volume of atmosphere passed over the plurality of surfaces 505 can be dependent upon, for example, the humidity of the atmosphere detected by the at least one humidity sensor 525 (e.g., the volume of atmosphere passed over the surfaces can increase as the relative humidity decreases and vice versa). The at least one humidity sensor 525, the control circuit 565 and the wiper movement mechanism 540 can all be in electrical communication with each other using any suitable type of electrical connection.

Exemplary embodiments of the present invention can be used for producing potable water in any area of the world where potable water is needed. For purposes of illustration and not limitation, for the embodiment illustrated in FIG. 5, the system 500 can be comprised of two surfaces 505, each surface being approximately four feet wide and six feet long. Each of the two surfaces 505 can be comprised of tempered glass approximately one-quarter inch thick and sealed to the other surface to form an enclosure that is also one-quarter of an inch thick (for holding the cooling fluid), for a total thickness of three-quarters of an inch for the sealed enclosure 510. Numerous such enclosures can be used together. For example, twenty-nine such enclosures can be held in, for example, a cage that is approximately seven feet by five feet. By appropriately controlling the flow of atmosphere over the surfaces of the enclosures using the atmosphere flow regulator 560 (depending on the amount of humidity in the area the system is being used), exemplary embodiments of the present invention are capable of producing approximately 100 liters of potable water an hour.

Additionally, exemplary embodiments can be transported and assembled in a number of remote areas inhabited by humans where little or no natural resources are available for producing potable water. Furthermore, exemplary embodiments of the present invention can be accessible to individuals with limited technical expertise and be available in a range of sizes so that it can be used in areas that lack abundant space.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. A system for producing potable water from atmosphere, comprising:
a first surface;
a second surface arranged substantially parallel to the first surface,
wherein the first and second surfaces are comprised of a material on which water condensation from the atmosphere forms in response to a temperature differential between the material and the atmosphere,
wherein a seal is formed around a periphery of the first and second surfaces to form an enclosure between the first and second surfaces, and
wherein the enclosure is filled with a liquid;
a cooling device positioned within the liquid within the enclosure;
a sensor circuit located proximate to the first and second surfaces,
wherein the sensor circuit is configured to detect an amount of water condensate formed on the first and second surfaces in response to cooling of the first and second surfaces by the liquid cooled by the cooling device;
a wiper in contact with each of the first and second surfaces,
wherein the wiper is configured to remove water condensate from the respective first and second surfaces when the sensor circuit detects the amount of water condensate formed on the respective first and second surfaces exceeds a predetermined value; and
a collector for collecting the water condensate removed from the first and second surfaces for use as potable water.

2. The system of claim 1, wherein the first and second surfaces comprise glass.

3. The system of claim 1, wherein the first and second surfaces comprise metal.

4. The system of claim 1, wherein the first and second surfaces comprise plastic.

5. The system of claim 1, wherein the liquid comprises water.

6. The system of claim 1, wherein the liquid comprises alcohol.

7. The system of claim 1, wherein each of the first and second surfaces are substantially rectangular.

8. The system of claim 1, wherein each of the first and second surfaces are substantially circular.

9. The system of claim 1, wherein each of the first and second surfaces are substantially planar.

10. The system of claim 1, comprising:
a sterilizer for sterilizing the collected water condensate to produce the potable water.

11. The system of claim 1, comprising:
an atmosphere flow regulator for passing atmosphere over the first and second surfaces.

12. The system of claim 11, comprising:
a control circuit for controlling the atmosphere flow regulator to control a passage of atmosphere over the first and second surfaces,
wherein a volume of atmosphere passed over the first and second surfaces is dependent upon a humidity of the atmosphere detected by the sensor circuit.

13. The system of claim 1, comprising:
a cooling fluid supplier for supplying a cooling fluid through the cooling device to cool the liquid within the enclosure.

14. The system of claim 13, wherein the cooling fluid supplier comprises a condenser.

15. The system of claim 1, wherein the cooling device comprises a refrigeration coil.

16. The system of claim 1, wherein the cooling device comprises a plurality of pipes, and
wherein a cooling fluid is passed through each of the plurality of pipes to cool the liquid within the enclosure.

17. The system of claim 1, wherein the wiper comprises a squeegee.

18. A system for producing potable water from atmosphere, comprising:
a plurality of surfaces arranged to form a sealed enclosure,
wherein the enclosure is substantially filled with a liquid, and
wherein each of the plurality of surfaces is comprised of a material on which water condensation from the atmosphere forms when there is a temperature differential between the material and the atmosphere;
a cooling coil positioned within the liquid within the enclosure,
wherein the cooling coil is configured to cool the liquid within the enclosure to cool the plurality of surfaces;
at least one humidity sensor located proximate to the plurality of surfaces,
wherein of the at least one humidity sensor is configured to detect an amount of water condensate formed on the plurality of surfaces;
a plurality of wipers,
wherein each of the plurality of wipers is associated with a surface of the plurality of surfaces, and
wherein each of the plurality of wipers is configured to remove water condensate from each of the plurality of surfaces when the at least one humidity sensor detects the amount of water condensate formed on the plurality of surfaces exceeds a predetermined value; and
a collector for collecting the water condensate removed from the plurality of surfaces for use as potable water.

19. The system of claim 18, wherein each of the plurality of surfaces comprises glass.

20. The system of claim 18, wherein the liquid comprises water.

21. The system of claim 18, comprising:
a sterilizer for sterilizing the collected water condensate to produce the potable water.

22. The system of claim 18, comprising:
an atmosphere flow regulator for passing atmosphere over the plurality of surfaces.

23. The system of claim 22, comprising:
a control circuit for controlling the atmosphere flow regulator to control a passage of atmosphere over the plurality of surfaces,
wherein a volume of atmosphere passed over the plurality of surfaces is dependent upon a humidity of the atmosphere detected by the at least one humidity sensor.

24. The system of claim 18, comprising:
a cooling fluid supplier for supplying a cooling fluid through the cooling device to cool the liquid within the enclosure.

25. A system for producing potable water from atmosphere, comprising:
a conduit,
wherein the conduit is comprised of a material on which water condensation from the atmosphere forms in response to a temperature differential between the material and the atmosphere,
wherein a cooling fluid is passed through the conduit to cool the conduit;
a sensor circuit located proximate to a surface of the conduit,
wherein the sensor circuit is configured to detect an amount of water condensate formed on the surface of the conduit in response to cooling of the conduit by the cooling fluid;
a wiper in circumferential contact with the surface of the conduit,
wherein the wiper is configured to remove water condensate from the surface of the conduit when the sensor circuit detects the amount of water condensate formed on the surface of the conduit exceeds a predetermined value; and
a collector for collecting the water condensate removed from the conduit for use as potable water.

26. A system for producing potable water from atmosphere, comprising:
a first surface;
a second surface arranged substantially parallel to the first surface,
wherein the first and second surfaces are comprised of a material on which water condensation from the atmosphere forms in response to a temperature differential between the material and the atmosphere,
wherein a seal is formed around a periphery of the first and second surfaces to form an enclosure between the first and second surfaces, and
wherein the enclosure is filled with a liquid;
means for cooling positioned within the liquid within the enclosure;
sensing means for detecting an amount of water condensate formed on the first and second surfaces in response to cooling of the first and second surfaces by the liquid cooled by the means for cooling,
wherein the sensing means is located proximate to the first and second surfaces;
means for removing water condensate from the respective first and second surfaces when the sensing means detects the amount of water condensate formed on the respective first and second surfaces exceeds a predetermined value,
wherein the means for removing is in contact with each of the first and second surfaces; and
means for collecting the water condensate removed from the first and second surfaces for use as potable water.

27. A system for producing potable water from atmosphere, comprising:
a conduit means for conveying a cooling fluid for cooling the conduit means,
wherein the conduit means is comprised of a material on which water condensation from the atmosphere forms in response to a temperature differential between the material and the atmosphere;
a sensor means for detecting an amount of water condensate formed on the surface of the conduit means in response to cooling of the conduit means by the cooling fluid,
wherein the sensor means is located proximate to a surface of the conduit means;
means for removing water condensate from the surface of the conduit means when the sensor means detects the amount of water condensate formed on the surface of the conduit means exceeds a predetermined value,
wherein the means for removing is in circumferential contact with the surface of the conduit means; and
means for collecting the water condensate removed from the conduit means for use as potable water.

28. A system for producing potable water from atmosphere, comprising:
a conduit on which water condensate from the atmosphere forms,
wherein a cooling fluid is passed through the pipe to cool the pipe, and
wherein the water condensate forms on a surface of the pipe in response to cooling of the pipe by the cooling fluid;
a wiper in circumferential contact with the surface of the pipe,
wherein the wiper is configured to remove water condensate from the surface of the pipe at predetermined intervals;
a collector for collecting the water condensate removed from the surface of the conduit; and
a sterilizer for sterilizing the collected water condensate to produce potable water.

29. A method of producing potable water from atmosphere, comprising the steps of:
a.) enclosing a cooling device within a liquid within an enclosure, wherein surfaces of the enclosure are comprised of a material on which water condensation from the atmosphere forms in response to a temperature differential between the material and the atmosphere;
b.) cooling the liquid in the enclosure to cool the surfaces of the enclosure;
c.) detecting an amount of water condensate formed on the surfaces in response to cooling of the surfaces by the liquid cooled by the cooling device;
d.) removing water condensate from the surfaces of the enclosure when the amount of water condensate formed on the surfaces exceeds a predetermined value; and
e.) collecting the water condensate removed from the surfaces of the enclosure for use as potable water.

30. A system for producing potable water from atmosphere, comprising:
a plurality of surfaces arranged to form a sealed enclosure,
wherein each of the plurality of surfaces is comprised of a material on which water condensation from the atmosphere forms when there is a temperature differential between the material and the atmosphere;
a cooling fluid supplier in fluid communication with the sealed enclosure for supplying a cooling fluid within the sealed enclosure;
at least one humidity sensor located proximate to the plurality of surfaces,
wherein the at least one humidity sensor is configured to detect an amount of water condensate formed on the plurality of surfaces;
a plurality of wipers,
wherein each of the plurality of wipers is associated with a surface of the plurality of surfaces, and
wherein each of the plurality of wipers is configured to remove water condensate from each of the plurality of surfaces when the at least one humidity sensor detects the amount of water condensate formed on the plurality of surfaces exceeds a predetermined value; and
a collector for collecting the water condensate removed from the plurality of surfaces for use as potable water.
